(19) United States
(12) Patent Application Publication
(10) Pub. No.: US 2008/0034979 A1
(43) Pub. Date: Feb. 14, 2008

(54) Multi purpose drip guard

(76) Inventor: Pamela C. Ress, South Lyon, MI (US)

Correspondence Address: Pamela C. Ress, 9937 Timothy Lane, South Lyon, MI, 49178, US

(21) Appl. No.: 11/582,045

(22) Filed: Oct. 18, 2006

Related U.S. Application Data
(60) Provisional application No. 60/837,191, filed on Aug. 14, 2006.

(51) Int. Cl. A47J 37/04

(52) U.S. Cl. 99/419

(57) ABSTRACT

a Multi Purpose drip Guard comprised of 1 receiving placement cut out 2 solid surface inter-locking mechanism 3 flat surface mechanism 4 platform elevating mechanism.

### CROSS-REFERENCE TO RELATED APPLICATIONS

This application relates to and claims priority from U.S. Provisional Patent Application Ser. No. US 60/837,191 filed on Aug. 14, 2006, specifications which are incorporated herein by reference.

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to a more sanitary surrounding which n turn creates a more clean environment surrounding a chocolate fountain which will also reduce waste from chocolate dripping and falling all over the dipping foods which in turn will reduce cost because of less wasted dipping foods, not to mention the invention also serves as a decorative multi purpose stand.

2. Background of Invention

In standard chocolate fountain catering practices in the commercial industry, as well as the home use setting the end user has always had a problem with mess surrounding the chocolate fountain environment. In fact, some establishments will not even allow a chocolate fountain in their facility because of the wasted linens as well as the mess a chocolate fountain can create. The way a chocolate fountain is set up to reduce mess is with linen placed around the fountain itself. Not only is this a waste of linen but when the guest dip their foods in the fountain the kinetic force from the chocolate falling spray s chocolate over a majority of the dipping foods.

(a) The chocolate fountain owner operator has an unsanitary environment.

(b) The chocolate fountain owner operator has a larger mess to consistently clean

(c) The chocolate fountain owner operator has more wasted time by way of replacing linens

(d) The chocolate fountain owner operator has more waste in dipping foods.

(e) The chocolate fountain owner operator has placement issues because of mess.

### BACKGROUND OF INVENTION—OBJECTS AND ADVANTAGES

Accordingly besides the objects and advantages of the Multi Purpose drip Guard described in my above patent, several objects and advantages of the present invention are:

(a) The chocolate fountain owner operator will have a more sanitary environment using Multi Purpose drip Guard.

(b) The chocolate fountain owner operator has a reduced amount of time cleaning up after guest using the Multi Purpose drip Guard.

(c) The chocolate fountain owner operator has a less time restraints by way of not replacing linens consistently using the Multi Purpose drip Guard

(d) The chocolate fountain owner operator will reduce waste of dipping foods by using the Multi Purpose Drip Guard.

(e) The issue of placement in facilities will be reduced because of the Multi Purpose drip Guard.

### SUMMARY

In accordance with the present invention, a Multi Purpose Drip Guard will be comprised of a transparent or non transparent platform. An illumination device or non illumination device. An elevating apparatus to raise the transparent platform. An inter locking mechanism to create a raised sold flat surface.

### DRAWINGS—FIGURES

FIGS. 1 (1) through 1 (4) illustrates various aspects of the Multi Purpose drip Guard in respect to a top view

FIGS. 2 (1) through 2 (3) illustrates various aspects of the Multi Purpose drip Guard in a opaque view.

FIGS. 3 (1) through 3 (2) illustrates various aspects of the Multi Purpose drip Guard in a side view.

### DRAWINGS—REFERENCE NUMERALS

1 Receiving Placement

2 Solid Surface Inter-Locking Mechanism

3 Flat surface

4 Platform Elevating Mechanism

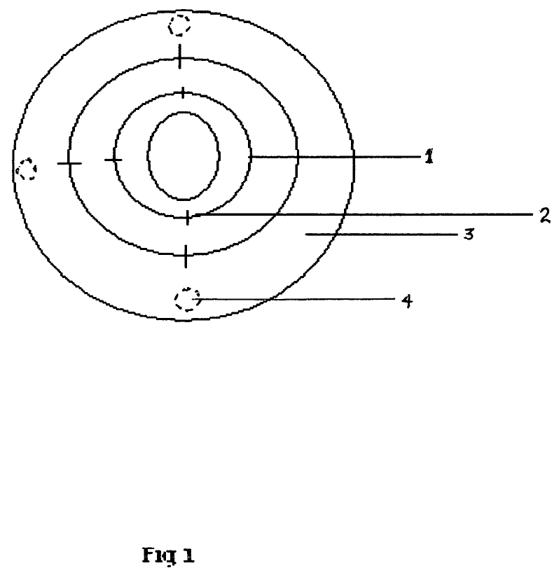

### DETAILED DESCRIPTION—FIGS. 1(1) THROUGH 1(4), 2(1) THROUGH 2(3) AND 3(3) THROUGH 3(4)

A preferred embodiment of the present invention is illustrated in FIG. 1 (top view) illustrates the Multi Purpose drip Guard has 1 a receiving placement mechanism cut out of 3 flat surface. The Solid surface inter-locking mechanism 2 is attached and or adhered to 3 the flat surface. The elevating apparatus 4 is adhered to 3 flat surface.

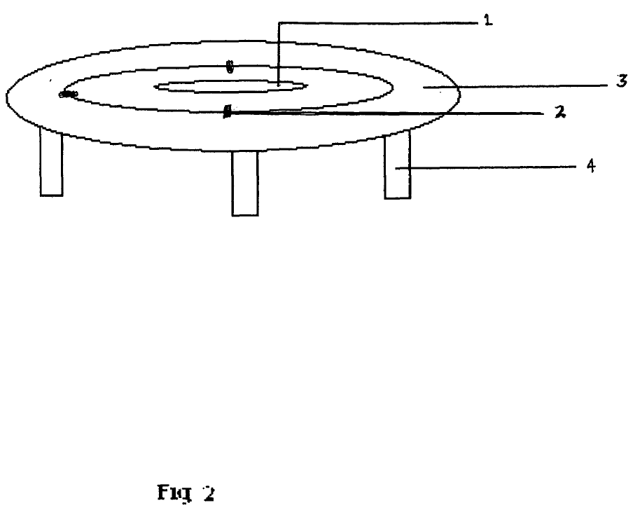

A preferred embodiment of the present invention is illustrated in FIG. 2 (opaque view) illustrates the Multi Purpose Drip Guard has 1 a receiving placement mechanism cut out of 3 flat surface. The Solid surface inter-locking mechanism 2 is attached and or adhered to 3 the flat surface. The elevating apparatus 4 is adhered to 3 flat surface.

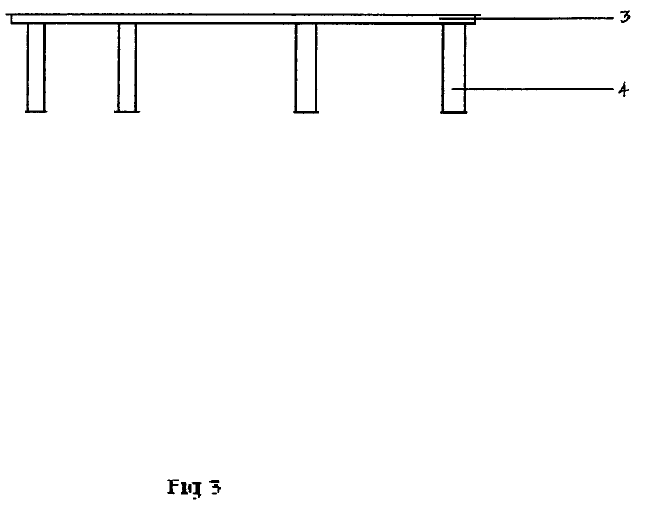

A preferred embodiment of the present invention is illustrated in FIG. 3 (side view) illustrates 3 flat surface adhered to 4 elevating apparatus.

### Operation—FIGS. 1-3

The manner of using the Multi Purpose drip Guard 1 receiving placement to receive the chocolate fountain 2 flat surface to catch the excess dripped chocolate 3 use the inter-locking mechanism to create a multi purpose stand 4 to raise the flat surface 3 off the table.

### Advantages

From the description above a number of advantages of my Multi Purpose drip Guard become clear and evident. (a) The chocolate fountain owner operator will have a more sanitary environment using Multi Purpose drip Guard.

(b) The chocolate fountain owner operator has a reduced amount of time cleaning up after guest using the Multi Purpose drip Guard.

(c) The chocolate fountain owner operator has a less time restraints by way of not replacing linens consistently using the Multi Purpose drip Guard

(d) The chocolate fountain owner operator will reduce waste of dipping foods by using the Multi Purpose Drip Guard.

(e) The issue of placement in facilities will be reduced because of the Multi Purpose drip Guard.

### CONCLUSION, RAMIFICATIONS, AND SCOPE

Accordingly the reader will see that the Multi Purpose drip Guard will become a revolution in the catering industry as well as home use. The Multi Purpose drip Guard product is user friendly and easy for anyone to use. Furthermore, the reader will see how great it will be to find more venues. To add, the Multi Purpose drip Guard will decrease amount of food, linens waste and time in cleaning up.
The chocolate fountain owner operator will have a more sanitary environment surrounding the chocolate fountain using the Multi Purpose drip Guard.
The chocolate fountain owner operator will no longer have to continually keep cleaning the area around the chocolate fountain using the Multi Purpose Drip Guard.
The chocolate fountain owner operator will reduce the amount of linen waste using the Multi Purpose drip Guard.
The chocolate fountain owner operator will reduce the amount of dipping food waste using the Multi Purpose drip Guard.
The chocolate fountain owner operator will have more opportunities in with creating new business

Although the description above outlines many specifications it should not be mis interpreted to limiting the scope of the invention. But as merely providing illustrations of some of the presently preferred embodiments of this invention For example the Multi Purpose drip Guard can be shaped differently then circular, the Multi Purpose drip Guard could have many tiers. The Multi Purpose drip Guard may be illuminated or may not be illuminated.

We claim:

1. A method for creating an illuminated barrier from linen and food while using a chocolate fountain by way of the above said present invention.
(i) Receiving placement cut out
(ii) Solid surface inter-locking mechanism
(iii) Flat surface mechanism
(iv) Platform elevating mechanism

2. A method for creating an illuminated raised flat surface for display
(i) Receiving placement cut out
(ii) Solid surface inter-locking mechanism
(iii) Flat surface mechanism
(iv) Platform elevating mechanism
